(19) United States
(12) Patent Application Publication
(10) Pub. No.: US 2026/0049886 A1
(43) Pub. Date: Feb. 19, 2026

(54) SCALABLE SYSTEM FOR MEASUREMENT AND TRANSFER OF DATA FROM INSIDE A PIPELINE DISPOSED SUBSEA AND METHODS OF USE

(71) Applicant: Oceaneering International, Inc., Houston, TX (US)

(72) Inventors: Sam ALMERICO, The Woodlands, TX (US); Greg Robert BOYLE, Camarillo, CA (US); Christopher LEON, Cypress, TX (US); Ryan W. WEEDEN, Willis, TX (US)

(73) Assignee: Oceaneering International, Inc., Houston, TX (US)

(21) Appl. No.: 19/299,647

(22) Filed: Aug. 14, 2025

Related U.S. Application Data
(60) Provisional application No. 63/682,973, filed on Aug. 14, 2024.

(51) Int. Cl. G01M 3/28; F17D 5/06; G01M 3/00

(52) U.S. Cl. CPC G01M 3/2815; F17D 5/06; G01M 3/002

(57) ABSTRACT

An operationally unintrusive, and scalable system for measurement and transfer of pressure and temperature data from inside a fluid flow tubular such as a subsea pipeline to an existing remote site such as an infrastructure or a subsea vehicle that does not need to penetrate the fluid flow tubular's wall.

### RELATION TO OTHER APPLICATIONS

This application claims priority through U.S. Provisional Application 63/682,973 filed on Aug. 14, 2024, incorporated herein by reference.

### BACKGROUND

With respect to examining subsea pipelines, dragging a sensor array with a long cable through the pipeline is the only current way to attain data such as pressure and temperature data. The overall problem measuring parameters for these data, e.g., internal temperature and pressure inside a pipe, is well known.

### FIGURES

Various figures are included herein which illustrate aspects of embodiments of the disclosed inventions.

FIG. 1 is a view in partial perspective of a first embodiment of a communication and power transmission system;

FIG. 2 is a schematic view of an embodiment of a communication and power transmission system;

FIG. 3 is a schematic view of a further embodiment of a communication and power transmission system;

FIG. 4 is a schematic view of a further embodiment of a communication and power transmission system;

FIG. 5 is a schematic view of an embodiment of a communication and power transmission system;

FIG. 6 is a schematic view of a magnetic wheatstone simulation of power transfer;

FIGS. 7-9 are schematic views of “see-through”systems;

FIGS. 10-11 are partially transparent views of exemplary inside and outside modules positioned about a tubular such as a fluid flow tubular.

### DESCRIPTION OF EXEMPLARY EMBODIMENTS

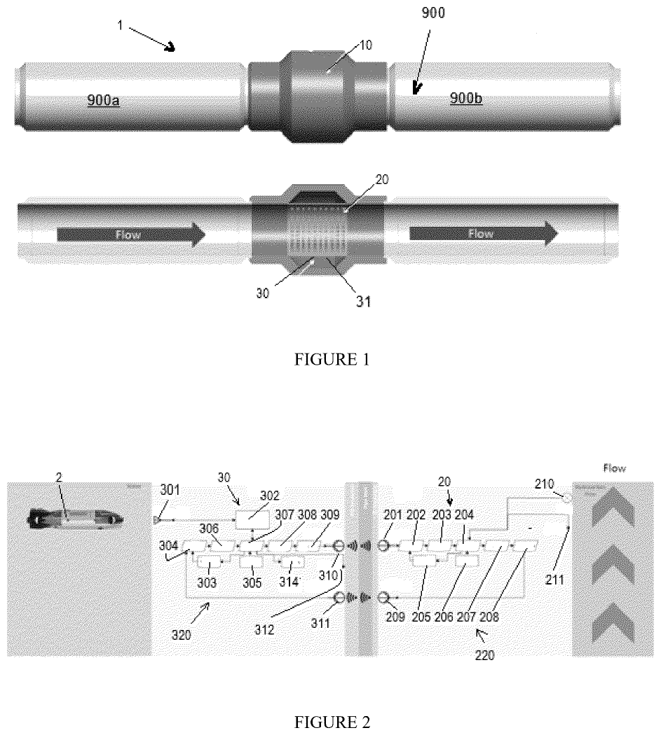

Referring generally to FIGS. 1 and 2 in most embodiments, system 1 has the ability to reliably communicate data, e.g., regarding pressure and temperature, over an extended period in an extreme and inaccessible environment, e.g., inside a pipe that is under water at a distance such as up to or around 6000 m and comprises inside module 20, outside module 30, and spool piece 10, although different embodiment are also currently contemplated as discussed herein, e.g., outside module 30, in embodiments, may differ in its configuration and operation. Outer module 30 may further comprise housing 31 disposed partially about outer surface of spool piece 10 or fluid flow tubular 900. Typically, inner module 20 and/or outside module 30 adhere to the inside or the outside of spool piece 10 or fluid flow tubular 900, as described herein. As used herein, fluid flow tubular 900 may be a pipeline or similar structure, typically disposed subsea.

Inside module 20 is used to sense and communicate various measurements such as temperature and pressure data to outside module 30 which, in turn, is typically responsible for storing and communicating that data to a remote site such as a remotely operated vehicle 2 or a terrestrial location. Outside module 30 and/or inside module 20 may alternatively be configured to adhere to an inside or an outside of spool piece 10 or fluid flow tubular 900. A power source, e.g., power source 305, typically comprises a wireless power source that provides electrical power and can be re-charged inside fluid flow tubular 900. Additionally, communication typically occurs wirelessly to provide data from inside fluid flow tubular 900 to an outside of fluid flow tubular 900 and, thereafter, to the remote site.

In a first embodiment, referring generally to FIG. 2, scalable system 1 for measurement and transfer of data from inside pipeline 900 disposed subsea, comprises spool piece 10 (FIG. 1) configured to be disposed intermediate two fluid flow tubulars 900a,900b (FIG. 1) and to allow fluid flow from a first of the two fluid flow tubulars to a second of the two fluid flow tubulars; inside module 20 dimensioned to be disposed within spool piece 10 or fluid flow tubular 900; and, typically, outside module 30 configured to be disposed within spool piece 10 or fluid flow tubular 900.

Inside module 20 typically comprises one or more inside module power sources 206; one or more inside sensors 210,211 operatively connected to inside power source 206 and configured to be disposed within a predetermined fluid flow tubular of the two fluid flow tubulars 900a,900b or spool piece 10 or both; inside data processor 220 operatively connected to inside power source 206; and one or more inside module antennae 201,209 operatively connected to inside data processor 220. Inside sensor 210,211 may comprise temperature sensor 210, pressure sensor 211, or both temperature sensor 201 and pressure sensor 211.

In embodiments, outside module 30 comprises one or more outside module power sources 305; outside data processor 320 operatively connected to outside module power source 305; data communicator 301 operatively in communication with outside data processor 320; one or more outside sensors 312, which may comprise a temperature sensor, operatively in communication with data processor 320 and operatively connected to outside module power source 305; and one or more outside data antennae 310, 311 operatively in communication with outside data processor 320 and operative to receive sensed data from inside sensor 210,211.

In most embodiments, data communicator 301 may further be configured to be operatively in communication with a remote site, e.g., remotely operated vehicle 2 or a terrestrial site.

Inside module power source 206, outside module power source 305, or both inside module power source 206 and outside module power source 305 may comprise a wireless power provider and, further, typically comprise one or more batteries which may be rechargeable in situ.

In embodiments, inside data processor 220 comprises wireless data transmitter 208, which can comprise a piezo data driver, and data receiver 202, e.g., a low noise amplifier (LNA), and outside data processor 320 comprises wireless data transmitter 310 cooperatively coupled to inside module antenna 201 and wireless data receiver 311 cooperatively coupled to inside module antenna 209.

In embodiments, outside data processor 320 may further comprise data receiver 311 operatively in communication with inside sensor 210,211 such as via inside module antenna 209; data transmitter 310 configured to cooperatively communicate with inside module antenna 201; and data store 314 operatively in communication with data receiver 311 and data transmitter 310, where data store 314 is configured to store sensed data from data receiver 311 and provide stored data to data transmitter 301.

In embodiments, inside module 20 may comprise one or more of a piezo transducer, a near field magnetic inducer, an acoustic wheatstone, a magnetic wheatstone, a “see through” sensor, external mechanical sensor, a fiberoptics sensor such as a Bragg gradings sensor, a capacitive coupler sensor, a chemical doser, or a mini-pig, or the like, or a combination thereof.

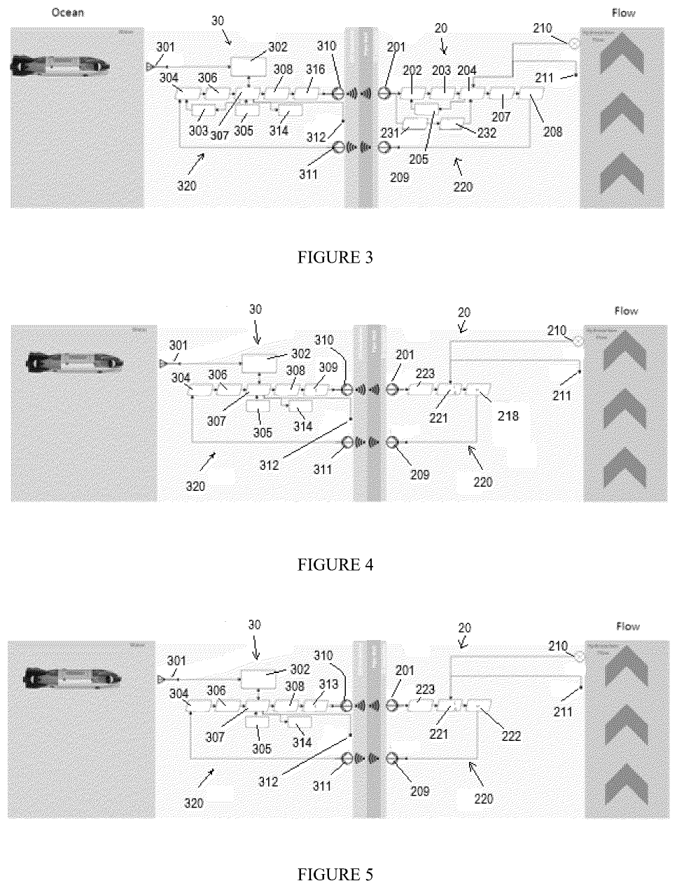

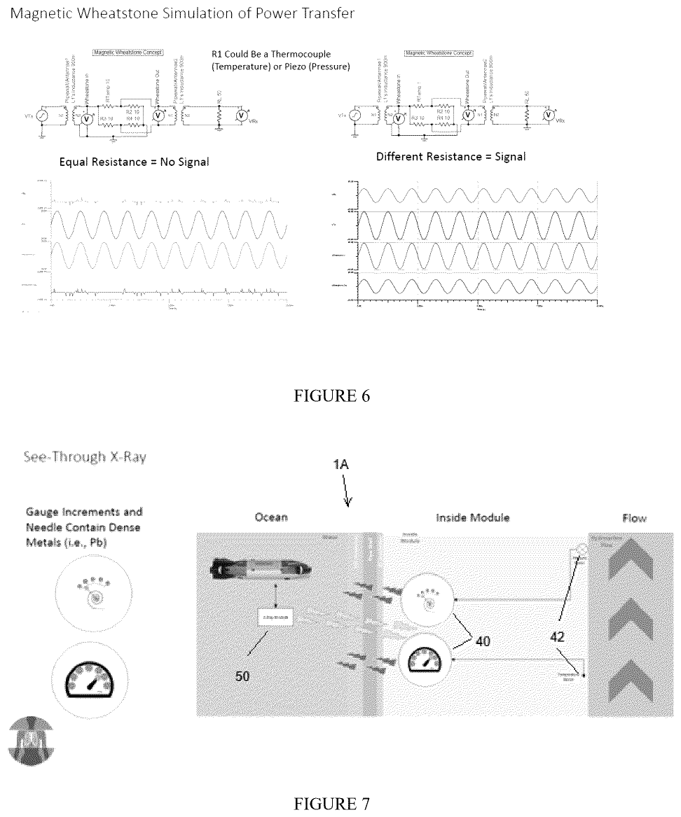

Referring to FIG. 3, where inside module comprises piezo transducer 208, piezo transducer 208 is typically configured to respond to a signal imparted on it from outside fluid flow tubulars 900a,900b, e.g., from sensors 210,211, and the sensed data are representative of a predetermined internal flow parameter such as pressure or temperature or the like or a combination thereof. In this embodiment, the signal typically comprises an acoustic or ultrasonic pressure wave. Data communicator 301 comprises a communication array; outside module data antennae 310,311 comprise outside data transmitter 310 and outside data receiver 311; and outside data processor 320 comprises outside data communicator 302, LNA 304 operatively in communication with outside data communicator 302 and with outside data antenna 311, analog-to-digital converter (ADC) 306 operatively in communication with LNA 304, microcontroller (MCU) 307, e.g., an intelligent semiconductor integrated circuit comprising processor unit, a memory module, a communication interface and/or peripherals which is operatively in communication with outside module power source 314, outside data processor 320, ADC 306, and data store 314; a transmit/receive (T/R) switch 303 operatively in communication with MCU 307 and LNA 304; digital-to-analog converter (DAC) 308 operatively in communication with MCU 307; and driver 316, which can comprise a piezo driver, operatively in communication with DAC 308 and with data send antenna 310. In this embodiment, inside module antennae 201,209 typically comprise data receive antenna 201 and data send antenna 209 and inside data processor 220 further typically comprises LNA 202 operatively in communication with data receive antenna 201, ADC 203 operatively in communication with LNA 202, T/R switch 205 operatively in communication with LNA 202; MCU 204 operatively in communication with inside module sensor 210,211, ADC 203, T/R switch 205, and inside module power source 206; DAC 207 operatively in communication with MCU 204; and piezo data driver 208 operatively in communication with DAC 207 and with data send antenna 209.

Referring still to FIG. 3, where inside sensor 210,211 comprises a near field magnetic inductor, the near field magnetic inductor typically comprises a magnetic inductor, e.g., a conventional magnetic inductor using an external coil creating a time varying magnetic field that couples with an inductive coil via mutual inductance. This mutual inductance can be used to charge a battery that powers a sensor module inside fluid flow tubulars 900a,900b, e.g., inside module power supply 206. The mutual inductance can also be used as a bi-directional digital or analog communication mechanism. In this embodiment, data communicator 301 typically comprises a communication array and outside data antenna 310,311 typically comprises outside data transmitter 310 and outside data receiver 311. Outside data processor 320 typically comprises outside data communicator 302; LNA 304 operatively in communication with outside data communicator 302 and with outside data antenna 311; ADC 306 operatively in communication with LNA 304; MCU 307, operatively in communication with outside module power source 305, ADC 306, and data store 314; T/R switch 303 operatively in communication with MCU 307 and LNA 304; DAC 308 operatively in communication with MCU 307; and driver 316 operatively in communication with DAC 308 and with data send antenna 310. In this embodiment, inside module antennae 201,209 comprise data receive antenna 201 and data send antenna 209 and inside data processor 220 further comprises LNA 202 operatively in communication with data receive antenna 201; ADC 203 operatively in communication with LNA 202; T/R switch 205 operatively in communication with LNA 202; MCU 204 operatively in communication with sensor 210,211, ADC 203, T/R switch 205, and inside module power source 205; rectifier 231 operatively in communication with data receive antenna 201; power conditioner 232 operatively in communication with MCU 204 and rectifier 232; DAC 207 operatively in communication with MCU 204; and driver 230 operatively in communication with DAC 207 and with data send antenna 209.

Referring to FIG. 4, where inside sensor 210,211 comprises an acoustic wheatstone, the acoustic wheatstone is typically configured to respond to a signal imparted on it from outside fluid flow tubular 900a,900b where the sensed data are representative of a predetermined internal flow parameter such as pressure or temperature or the like or a combination thereof and the signal comprises an acoustic or ultrasonic pressure wave. In this embodiment, data communicator 301 comprises a communication array; outside data antennae 310,311 comprise outside data transmitter 310 and an outside data receiver 311; and outside data processor 320 comprises outside data communicator 302, LNA 304 operatively in communication with outside data communicator 302 and with outside data antenna 311, ADC 306 operatively in communication with LNA 304; MCU 307 operatively in communication with outside module power source 305, outside data processor 320, ADC 306, and data store 314, DAC 308 operatively in communication with MCU 307, and driver 309, which can comprise a piezo driver, operatively in communication with DAC 308 and with data send antenna 310. In this embodiment, inside module antennae 201,209 comprise data receive antenna 201 and data send antenna 209, and inside data processor 220 further comprises first resonator 223, second resonator 218, and acoustic wheatstone 221 operatively connected to first resonator 223 and second resonator 218.

Referring to FIG. 5, where inside sensor 210,211 comprises a magnetic wheatstone, the magnetic wheatstone is typically configured to respond to a signal imparted on it from outside fluid flow tubular 900a,900b where sensed data is indicative of a predetermined internal flow parameter such as pressure or temperature or the like or a combination thereof and the signal comprises a magnetic field. In this embodiment, outside data processor 320 typically comprises outside data communicator 302, LNA 304 operatively in communication with outside data communicator 302 and with the outside data antenna 311, ADC 306 operatively in communication with LNA 304; MCU 307 operatively in communication with outside module power source 305, outside data processor 302, ADC 306, and data store 314; DAC 308 operatively in communication with MCU 307; and driver 313 operatively in communication with DAC 308 and with data send antenna 310. In this configuration, inside module antennae 201,209 comprise data receive antenna 201 and data send antenna 209, and inside data processor 220 further comprises first resonator 223 operatively in communication with data receive antenna 301; magnetic wheatstone 221 operatively in communication with first resonator 223 and inside module sensor 210,211, and second resonator 218 operatively in communication with magnetic wheatstone 221 and with data send antenna 209. In embodiments where inside sensor 210,211 comprises a chemical doser, the chemical doser may further comprise a chemical dosing system disposed inside spool piece 10. Chemical dosing typically comprises a chemical dosing system disposed inside a pipe that adds pollutants into the flow. The concentration or type of chemical dosage would be relative to the temperature or pressure reading. The chemical properties could be measured downstream, and temperature and pressure could be decoded.

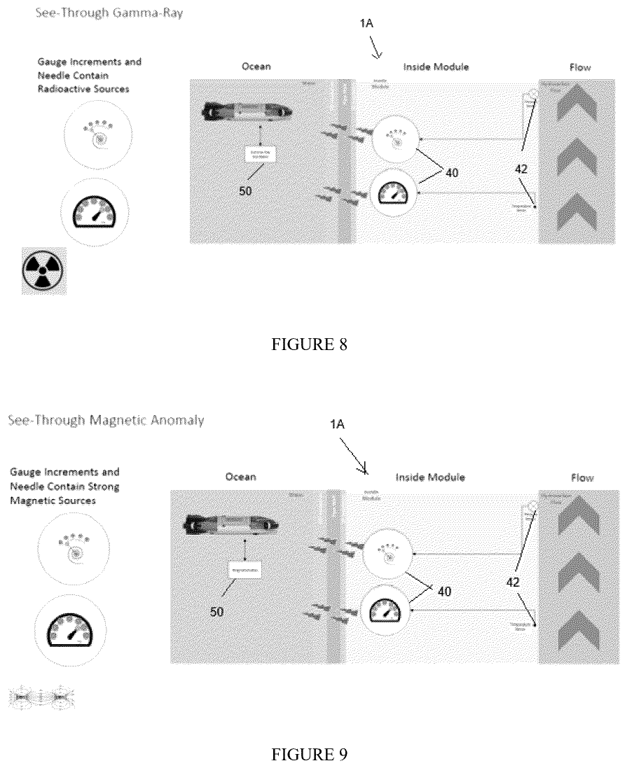

Referring to FIGS. 7-8, in a further embodiment, scalable system 1A comprises source 50 of a predetermined set of spectra or fields disposed outside the fluid flow tubular 900a,900b proximate a predetermined set of gauges 40 which are disposed at least partially within fluid flow tubular 900a,900b and predetermined set of sensors 42 operatively in communication with the predetermined set of gauges 40. The predetermined set of gauges 40 disposed inside fluid flow tubulars 900a,900b are visible to the predetermined set of spectra or fields, e.g., an X-ray spectrum or a gamma-ray spectrum. By way of example and not limitation, X-rays could be transmitted from outside fluid flow tubulars 900a,900b and reflect off of a dense metal such as lead on gauge 40 disposed inside fluid flow tubulars 900a,900b. In a further configuration of this embodiment, gauge 40 may be doped with one or more radioactive gamma ray sources, e.g., uranium, disposed inside fluid flow tubulars 900a,900b, and then “seen” outside fluid flow tubulars 900a,900b by an appropriate detector such as a gamma ray scintillator.

Referring to FIG. 9, in yet a further embodiment, gauge 40 may comprise one or more magnets and a magnetometer used to read gauge 40 from the outside of fluid flow tubulars 900a,900b.

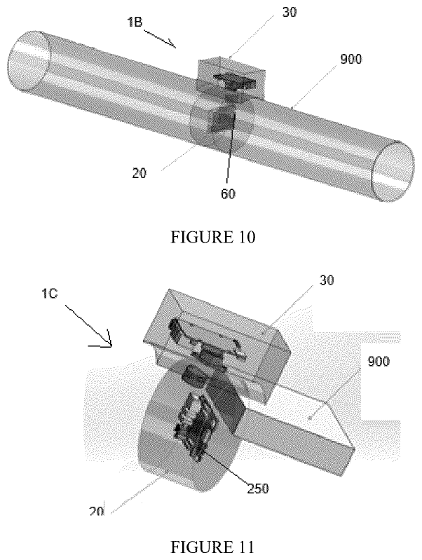

Referring to FIG. 10-12, in a further embodiment, scalable system 1B comprises sensor 60, e.g., a temperature or pressure sensor or the like or a combination thereof, which are affixed to a periphery of an outer diameter of fluid flow tubular 900a,900b. Sensors 60 may comprise strain gauges and thermocouples or the like or a combination thereof. By employing well known heat transfer or solid mechanics equations to the sensor's measurements, the internal temperature or pressure could be estimated with a fair amount of accuracy. Temperature may be a more feasible choice than pressure for this embodiment.

In a further embodiment, scalable system 1 may comprise a fiber optic cable wrapped around outer diameter of fluid flow tubular 900a,900b and used as a sensor. By way of example and not limitation, with fiber optics Bragg gradings can be used to detect temperature and pressure. The temperature and pressure measurements could be combined with heat transfer or solid mechanics equations to estimate the internal pressure and temperature of fluid flow tubular 900a,900b.

In embodiments where sensor 210 comprises a capacitor sensor, system 1 typically further comprises electric field source 250 disposed at least partially within fluid flow tubular 900a,900b and the capacitor sensor is configured to capacitively detect an electric field generated by electric field source 250. electric field source 250 may be configured to supply both power and data communication.

In embodiments, scalable system 1D comprises a predetermined set of mini-pigs 70, each mini-pig 70 typically comprising sensor 71 and memory 72, where each mini-pig 70 is configured to be small enough to be introduced into fluid flow tubular 900a,900b without impeding fluid flow within fluid flow tubular 900 when mini-pig 70 is added to the fluid flow. In this embodiment, mini-pig collector 74 is typically disposed at an exit of fluid flow from fluid flow tubular 900a,900b. Sensor 71 collects pressure or temperature data as mini-pig 70 traverses within fluid flow tubular 900 and allows retrieval of collected data when min-pig 70 is retrieved at a predetermined point in fluid flow tubular 900, e.g., at the end of fluid flow tubular 900.

In the operation of exemplary methods, referring back to FIG. 2, flow information of fluid within fluid flow tubular 900 may be substantially continuously telemetered by using system 1 as described herein by disposing spool piece 10 intermediate two fluid flow tubulars 900a,900b; providing fluid flow through two fluid flow tubulars 900a,900b and, if present, spool piece 10; sensing a predetermined set of data regarding the fluid flow using inside sensor 210,211; transmitting the sensed data to outside module 30 from inside module antenna 209 to outside data antenna 311; continuously receiving the transmitted data by outside data processor 320; and providing the sensed data to remote receiver 2.

In embodiments where inner module 20 comprises an acoustic wheatstone as described herein, the response comprises data indicative of a predetermined internal flow parameter such as pressure or temperature and the signal comprises an acoustic or ultrasonic pressure wave.

Where inner module 20 comprises a magnetic wheatstone as described above, the response typically comprises data indicative of a predetermined internal flow parameter such as pressure or temperature and the signal comprises a magnetic field.

The foregoing disclosure and description of the inventions are illustrative and explanatory. Various changes in the size, shape, and materials, as well as in the details of the illustrative construction and/or an illustrative method may be made without departing from the spirit of the invention.

1) A scalable system for measurement and transfer of data from inside a pipeline disposed subsea, comprising:
a) a spool piece configured to be disposed intermediate two fluid flow tubulars and to allow fluid flow from a first of the two fluid flow tubulars to a second of the two fluid flow tubulars;
b) an inside module dimensioned to be disposed within the spool piece or one of the two fluid flow tubulars, the inside module comprising:
i) an inside module power source;
ii) an inside sensor operatively connected to the inside power source and configured to be disposed within a predetermined fluid flow tubular of the two fluid flow tubulars or the spool piece;
iii) an inside data processor operatively connected to the inside power source; and
iv) an inside module antenna operatively connected to the inside data processor; and
c) an outside module configured to be disposed within the spool piece, the outside module comprising:
i) an outside module power source;
ii) an outside data processor operatively connected to the outside module power source;
iii) a data communicator operatively in communication with the outside data processor;
iv) an outside sensor operatively in communication with the data processor and operatively connected to the outside module power source; and
v) an outside data antenna operatively in communication with the data processor and operative to receive sensed data from the inside sensor.

2) The scalable system for measurement and transfer of data from inside a pipeline disposed subsea of claim 1, wherein the inside module power source, the outside module power source, or both the inside module power source and the outside module power source comprise a wireless power provider.

3) The scalable system for measurement and transfer of data from inside a pipeline disposed subsea of claim 1, wherein:
a) the inside sensor and the inside data processor comprise a cooperatively coupled wireless data transmitter and data receiver; and
b) the outside sensor and the outside data processor comprise a cooperatively coupled wireless data transmitter and data receiver.

4) The scalable system for measurement and transfer of data from inside a pipeline disposed subsea of claim 1, wherein:
a) the inside sensor comprises a temperature sensor, a pressure sensor, or both a temperature sensor and a pressure sensor; and
b) the outside sensor comprises a temperature sensor.

5) The scalable system for measurement and transfer of data from inside a pipeline disposed subsea of claim 1, wherein the outside data processor further comprises:
a) a data receiver operatively in communication with the inside sensor;
b) a data transmitter; and
c) a data store operatively in communication with the data receiver and the data transmitter, the data store configured to store sensed data from the data receiver and provide stored data to the data transmitter.

6) The scalable system for measurement and transfer of data from inside a pipeline disposed subsea of claim 1, wherein the inside sensor comprises a piezo transducer, a near field magnetic inducer, an acoustic wheatstone, a magnetic wheatstone, a “see through” sensor, external mechanical sensor, a fiberoptics sensor, a capacitive coupler sensor, a chemical doser, or a mini-pig.

7) The scalable system for measurement and transfer of data from inside a pipeline disposed subsea of claim 6, wherein:
a) the piezo transducer is configured to respond to a signal imparted on it from outside the fluid flow tubular, the sensed data representative of a predetermined internal flow parameter, the signal comprising an acoustic or ultrasonic pressure wave;
b) the data communicator comprises a communication array;
c) the outside data antenna comprises:
i) an outside data transmitter; and
ii) an outside data receiver;
d) the outside data processor comprises:
i) an outside data communicator;
ii) an low noise amplifier (LNA) operatively in communication with the outside data communicator and with the outside data antenna;
iii) an analog-to-digital converter (ADC) operatively in communication with the LNA;
iv) a microcontroller (MCU), operatively in communication with the outside module power source, the outside data processor, the ADC, and a data store;
v) a transmit/receive (T/R) switch operatively in communication with the MCU and the LNA;
vi) a digital-to-analog converter (DAC) operatively in communication with the MCU;
vii) a driver operatively in communication with the DAC and with the data send antenna;
e) the inside module antenna comprises:
i) a data receive antenna; and
ii) a data send antenna; and
f) the inside data processor further comprises:
i) an LNA operatively in communication with the data receive antenna;
ii) an ADC operatively in communication with the LNA;
iii) a T/R switch operatively in communication with the LNA;
iv) an MCU, operatively in communication with the sensor, the ADC, the T/R switch, and the inside module power source;
v) a DAC operatively in communication with the MCU; and
vi) a driver operatively in communication with the DAC and with the data send antenna.

8) The scalable system for measurement and transfer of data from inside a pipeline disposed subsea of claim 6, wherein:
a) the near field magnetic inductor comprises a magnetic inductor;
b) the data communicator comprises a communication array;
c) the outside data antenna comprises:
i) an outside data transmitter; and
ii) an outside data receiver;
d) the outside data processor comprises:
i) an outside data communicator;
ii) an LNA operatively in communication with the outside data communicator and with the outside data antenna;
iii) an ADC operatively in communication with the LNA;
iv) an MCU, operatively in communication with the outside module power source, the outside data processor, the ADC, and a data store;
v) a T/R switch operatively in communication with the MCU and the LNA;
vi) a DAC operatively in communication with the MCU;
vii) a driver operatively in communication with the DAC and with the data send antenna;
e) the inside module antenna comprises:
i) a data receive antenna; and
ii) a data send antenna; and
f) the inside data processor further comprises:
i) an LNA operatively in communication with the data receive antenna;
ii) an ADC operatively in communication with the LNA;
iii) a T/R switch operatively in communication with the LNA;
iv) an MCU, operatively in communication with the sensor, the ADC, the T/R switch, and the inside module power source;
v) a rectifier operatively in communication with the data receive antenna;
vi) a power conditioner operatively in communication with the MCU and the rectifier;
vii) a DAC operatively in communication with the MCU; and
viii) a driver operatively in communication with the DAC and with the data send antenna.

9) The scalable system for measurement and transfer of data from inside a pipeline disposed subsea of claim 6, wherein:
a) the data communicator comprises a communication array;
b) the outside data antenna comprises:
i) an outside data transmitter; and
ii) an outside data receiver;
c) the outside data processor comprises:
i) an outside data communicator;
ii) an LNA operatively in communication with the outside data communicator and with the outside data antenna;
iii) an ADC operatively in communication with the LNA;
iv) an MCU, operatively in communication with the outside module power source, the outside data processor, the ADC, and a data store;
v) a DAC operatively in communication with the MCU;
vi) a driver operatively in communication with the DAC and with the data send antenna;
d) the inside module antenna comprises:
i) a data receive antenna; and
ii) a data send antenna; and
e) the inside data processor further comprises:
i) a first resonator;
ii) a second resonator; and
f) an acoustic wheatstone operatively connected to the first resonator and the second resonator, the acoustic wheatstone configured to respond to a signal imparted on it from outside the fluid flow tubular, the sensed data representative of a predetermined internal flow parameter, the signal comprising an acoustic or ultrasonic pressure wave;

10) The scalable system for measurement and transfer of data from inside a pipeline disposed subsea of claim 6, wherein:
a) the outside data processor comprises:
i) an outside data communicator;
ii) an LNA operatively in communication with the outside data communicator and with the outside data antenna;
iii) an ADC operatively in communication with the LNA;
iv) an MCU, operatively in communication with the outside module power source, the outside data processor, the ADC, and a data store;
v) a DAC operatively in communication with the MCU;
vi) a driver operatively in communication with the DAC and with the data send antenna;
b) the inside module antenna comprises:
i) a data receive antenna; and
ii) a data send antenna; and
c) the inside data processor further comprises:
i) a first resonator operatively in communication with the data receive antenna;
ii) a second resonator operatively in communication with the data send antenna; and
d) a magnetic wheatstone operatively in communication with the first resonator, the inside module sensor, and the second resonator, the magnetic wheatstone configured to respond to a signal imparted on it from outside the fluid flow tubular, the sensed data configured to be indicative of a predetermined internal flow parameter.

11) The scalable system for measurement and transfer of data from inside a pipeline disposed subsea of claim 1, wherein the outside module is further configured to adhere to an inside or an outside of the spool piece or a fluid flow tubular.

12) The scalable system for measurement and transfer of data from inside a pipeline disposed subsea of claim 1, wherein the data communicator is further configured to be operatively in communication with a remote site (2).

13) A method of continuously telemetering flow information using a scalable system for measurement and transfer of data from inside a pipeline disposed subsea, comprising a spool piece configured to be disposed intermediate two fluid flow tubulars and to allow fluid flow from a first of the two fluid flow tubulars to a second of the two fluid flow tubulars; an inside module dimensioned to be disposed within the spool piece or one of the two fluid flow tubulars, the inside module comprising an inside module power source, an inside sensor operatively connected to the inside power source and configured to be disposed within a predetermined fluid flow tubular of the two fluid flow tubulars or the spool piece, an inside data processor operatively connected to the inside power source, and an inside module antenna operatively connected to the inside data processor; and an outside module configured to be disposed within the spool piece, the outside module comprising an outside module power source, an outside data processor operatively connected to the outside module power source, a data communicator operatively in communication with the outside data processor, an outside sensor operatively in communication with the data processor and operatively connected to the outside module power source, and an outside data antenna operatively in communication with the data processor and operative to receive sensed data from the inside sensor, the method comprising:
a) disposing the spool piece intermediate two fluid flow tubulars;
b) providing fluid flow through the spool piece;
c) sensing a predetermined set of data regarding the fluid flow using the inside sensor;
d) transmitting the sensed data to the outside module using the inside module antenna and the outside data antenna;
e) continuously receiving the transmitted data by the outside data processor; and
f) providing the sensed data to a remote receiver.

14) The method of continuously telemetering flow information using the system of claim 13, wherein the inner module comprises an acoustic wheatstone and the inside module sensor is disposed inside the two fluid flow tubulars or the spool piece and configured to respond to a signal imparted on it from outside two fluid flow tubulars or the spool piece, wherein:
a) the response comprises data indicative of a predetermined internal flow parameter; and
b) the signal comprises an acoustic or ultrasonic pressure wave.

15) The method of continuously telemetering flow information using the system of claim 13, wherein the inner module comprises a magnetic wheatstone and the inside module sensor is disposed inside the two fluid flow tubulars or the spool piece and configured to respond to a signal imparted on it from outside the two fluid flow tubulars or the spool piece, wherein:
a) the response comprises data indicative of a predetermined internal flow parameter; and
b) the signal comprises a magnetic field.
